(19) United States
(12) Patent Application Publication
(10) Pub. No.: US 2023/0211729 A1
(43) Pub. Date: Jul. 6, 2023

(54) Sound Generator for Electric Vehicles

(71) Applicant: K&N Engineering, Inc., Riverside, CA (US)

(72) Inventors: Wayne Jackson, Riverside, CA (US); Steve Williams, Cherry Valley, CA (US)

(21) Appl. No.: 18/089,954

(22) Filed: Dec. 28, 2022

Related U.S. Application Data
(60) Provisional application No. 63/296,295, filed on Jan. 4, 2022.

(51) Int. Cl. B60Q 5/00; H04R 1/02; H04R 3/00; G06F 3/16; G10K 15/02; G06F 8/65

(52) U.S. Cl. CPC B60Q 5/005; H04R 1/025; H04R 3/00; G06F 3/165; G10K 15/02; G06F 8/65; H04R 2420/07; H04R 2499/13

(57) ABSTRACT

An apparatus and methods are provided for a sound effect generation system for broadcasting engine sounds outside a vehicle. The sound effect generation system enables a driver to select and manipulate the sounds emitted outside the vehicle. The sound effect generation system includes a wireless sound generator module for simulating engine sounds, a speaker for broadcasting the engine sounds outside the vehicle, and an external GPS antenna for measuring a speed of the vehicle. When the vehicle is turned on and remains stationary, the sound generator module simulates an idling internal combustion engine. When the speed of the vehicle increases, revving of the internal combustion engine and transmission shifting are simulated. When the speed of the vehicle decreases, a decelerating internal combustion engine is simulated. The sound effect generation system includes settings that may be accessed by a wireless mobile device whereby the driver can manipulate the engine sounds.

### PRIORITY

This application claims the benefit of and priority to U.S. Provisional Application, entitled “Sound Generator For Electric Vehicles,” filed on Jan. 4, 2022, and having application Ser. No. 63/296,295, the entirety of said application being incorporated herein by reference.

### FIELD

Embodiments of the present disclosure generally relate to the field of electric vehicles. More specifically, embodiments of the disclosure relate to an apparatus and methods for a sound generator for an electric vehicle that enables a driver to select and manipulate the sounds emitted outside the vehicle.

### BACKGROUND

As the world attempts to move away from burning fossil fuels, electric vehicles (EVs) are gaining in popularity as a more sustainable alternative. However, EVs are not without certain difficulties. Once such difficulty has been the quietness of the electric motor comprising EVs. Pedestrians generally are accustomed to the sounds emitted by fossil fuel-burning vehicles, but the subdued sounds of many EVs have made it difficult for pedestrians to hear approaching EV traffic. These difficulties have been especially challenging for the visually impaired community.

In an attempt to make EVs discernable to visually impaired pedestrians, some nations have created electric car noise laws. Such laws generally require all new EVs, including hybrid vehicles, to have a noise-emitting device. For example, the European Union requires new EVs to be fitted with an acoustic vehicle alert system (AVAS), which makes a sound similar to a traditional engine to warn nearby pedestrians. The AVAS is required to sound when an EV is reversing as well as when travelling at less than 18.6 mph (30 km/h). Further, the minimum sound requirements for hybrid and EVs are that a pedestrian should be able to hear the EV over background noises.

Given the increasing popularity of EVs, there is a desire to develop and improve sounds associated with the operation of EVs that are discernable by pedestrians. Embodiments herein provide a sound generator for EVs that enables a driver to select and manipulate the sounds emitted outside the EV.

### SUMMARY

An apparatus and methods are provided for a sound effect generation system for broadcasting engine sounds outside a vehicle. The sound effect generation system enables a driver to select and manipulate the sounds emitted outside the vehicle. The sound effect generation system includes a wireless sound generator module for simulating engine sounds, a boost speaker for broadcasting the engine sounds outside the vehicle, and an external GPS antenna for measuring a speed of the vehicle. When the vehicle is turned on and remains stationary, the sound generator module simulates an idling internal combustion engine. When the speed of the vehicle increases, the sound generator module simulates revving of the internal combustion engine and shifting of a transmission. When the speed of the vehicle decreases, the sound generator module simulates a decelerating internal combustion engine. The sound effect generation system includes settings that may be accessed by way of a wireless mobile device whereby an end-user can manipulate the engine sounds.

In an exemplary embodiment, a sound effect generation system for broadcasting an engine sound outside a vehicle comprises: a wireless sound generator module for simulating the engine sound; a boost speaker for broadcasting the engine sound outside the vehicle; and an external GPS antenna for measuring a speed of the vehicle.

In another exemplary embodiment, the sound effect generation system further comprises a sound generator system stored on a memory of a mobile device that comprises at least one processor and has connectivity to the wireless sound generator module. In another exemplary embodiment, the sound generator system comprises a software application configured to operate on the mobile device and communicate with the wireless sound generator module by way of the wireless connection. In another exemplary embodiment, the sound generator system comprises an interface that provides access to a component systems package that comprises component systems that enable an end-user to interact with sound effects provided by way of the wireless sound generator module. In another exemplary embodiment, the component systems package comprises functions that are performed by the wireless sound generator module. In another exemplary embodiment, the interface is a software application that provides access to settings that control the functions performed by the component systems package.

In another exemplary embodiment, the wireless sound generator module is configured to simulate the engine sound when the vehicle is operating. In another exemplary embodiment, the engine sound is configured to resemble an idling internal combustion engine when the vehicle is turned on and remains stationary. In another exemplary embodiment, the engine sound simulates revving of the internal combustion engine and shifting of a transmission when the speed of the vehicle increases. In another exemplary embodiment, the engine sound simulates a decelerating internal combustion engine sound when the speed of the vehicle decreases.

In another exemplary embodiment, the boost speaker is enclosed in a suitable housing for being mounted outside the vehicle and protecting the boost speaker from potential environmental damage. In another exemplary embodiment, the external GPS antenna is configured to be installed onto a location of the vehicle that is suitable for receiving GPS data. In another exemplary embodiment, the wireless sound generator module is configured to determine the speed of the vehicle by way of the GPS data and one or more internal accelerometers. In another exemplary embodiment, the wireless sound generator module is configured to simulate engine revving and transmission shifting based on the GPS data and the one or more internal accelerometers.

In an exemplary embodiment, a wireless sound generator module for simulating an engine sound comprises: an engine rev system; a minimum operational voltage system; a wake-up system; a sound file header information read system; and a download system.

In another exemplary embodiment, the wireless sound generator module is configured to wirelessly communicate with a sound generator system comprising a software application operating on a mobile device whereby an end-user may select and control the engine sound to be simulated during operation of a vehicle. In another exemplary embodiment, the engine rev system is configured to simulate the engine sound during operation of a vehicle. In another exemplary embodiment, the minimum operational voltage system is configured to detect an available operational voltage and ensure that the wireless sound generator module does not fully function when the operational voltage drops below a minimal value.

In another exemplary embodiment, the wake-up system is configured to wake the wireless sound generator module from a low-current, sleep mode so that it can function normally. In another exemplary embodiment, the sound file header information read system is configured to read information included in the header portion of sound files so as to improve sound quality and make sound effects more realistic. In another exemplary embodiment, the download system is configured to enable end-users to obtain new sound files and firmware updates.

In an exemplary embodiment, a method for broadcasting an engine sound outside an operating vehicle comprises: providing a sound of an operating internal combustion engine; receiving sound-settings from an end-user; determining a speed of the operating vehicle; altering the sound according to the speed and the sound-settings; and broadcasting the sound outside the vehicle by way of a boost speaker.

In another exemplary embodiment, determining the speed includes utilizing GPS data and one or more accelerometers comprising a wireless sound generator module. In another exemplary embodiment, altering includes causing the sound to resemble an idling internal combustion engine when the vehicle is turned on and remains stationary. In another exemplary embodiment, altering includes simulating revving of the internal combustion engine and shifting of a transmission when the speed of the vehicle increases. In another exemplary embodiment, altering includes simulating a decelerating internal combustion engine sound when the speed of the vehicle decreases.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 is a schematic illustrating an exemplary embodiment of an EV sound effect generation system in accordance with the present disclosure;

FIG. 2 illustrates an exemplary use environment wherein a wireless connection is established between a wireless sound generator module connected to a vehicle and a mobile device;

FIG. 3A illustrates an exemplary embodiment of a touch screen that may be displayed on the mobile device of FIG. 2 while the sound generator module is connected to the vehicle;

FIG. 3B illustrates an exemplary embodiment of a touch screen that may be displayed on the mobile device of FIG. 2 while the sound generator module is connected to the vehicle;

FIG. 4 illustrates an exemplary embodiment of an EV sound effect generation system configured to provide a driver of a vehicle with control over sounds emitted outside the vehicle; and

FIG. 5 is a block diagram illustrating an exemplary data processing system that may be used with embodiments of an EV sound effect generation system according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the EV sound effect generation system and methods disclosed herein may be practiced without these specific details. In other instances, specific numeric references such as “first generator,” may be made. However, the specific numeric reference should not be interpreted as a literal sequential order but rather interpreted that the “first generator” is different than a “second generator.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

As the world moves away from burning fossil fuels, electric vehicles (EVs) are gaining in popularity as a more sustainable alternative. However, the quietness of the electric motors comprising EVs make it difficult for pedestrians, especially visually impaired pedestrians, to hear approaching EV traffic. In an attempt to make EVs discernable to visually impaired pedestrians, there is a desire to require EVs, including hybrid vehicles, to include a noise-emitting device. Such a noise-emitting device preferably produces sound when the EV is reversing as well as when travelling at relatively slow speeds. Given the increasing popularity of EVs, there is a desire to develop and improve sounds associated with the operation of EVs that are discernable by pedestrians. Embodiments herein provide a sound generator for EVs that enables a driver to select and manipulate the sounds emitted outside the EV.

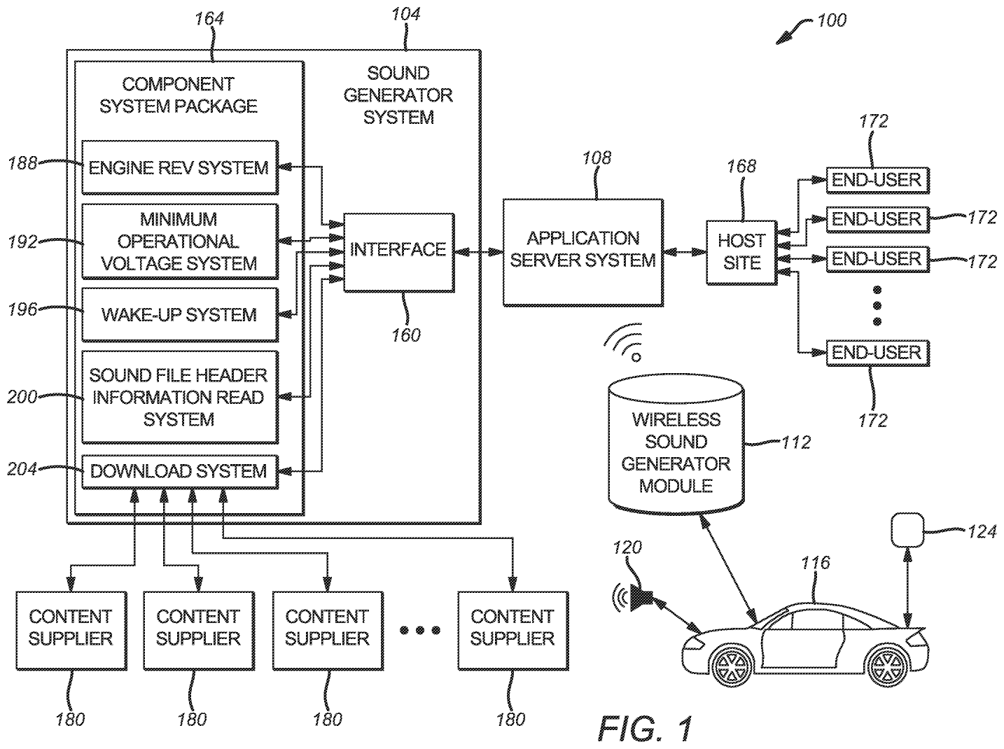

FIG. 1 is a schematic illustrating an exemplary embodiment of EV sound effect generation system 100 in accordance with the present disclosure. The EV sound generation system 100 comprises a sound generator system 104 stored on a non-transient machine-readable medium (i.e., a memory) of an application server system 108 which comprises at least one processor and has connectivity to a wireless sound generator module 112 that is connected to a vehicle 116. Generally, the wireless sound generator module 112 simulates an engine sound when the vehicle 116 is operating. The engine sound is emitted outside the vehicle 116 by way of a boost speaker 120. When the vehicle 116 is turned on and remaining stationary, the engine sound resembles an idling internal combustion engine. When the speed of the vehicle 116 increases, however, the engine sound simulates revving of the internal combustion engine and shifting of a transmission (not shown). Further, the engine sound simulates a decelerating internal combustion engine sound when the speed of the vehicle 116 is decreasing.

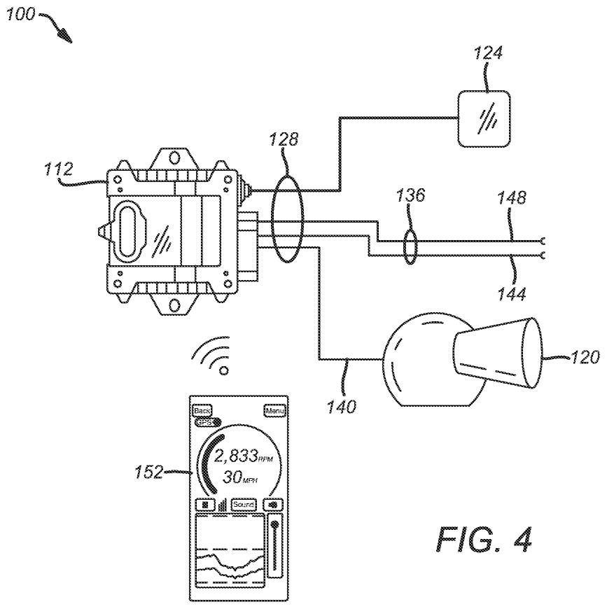

In an exemplary embodiment, illustrated in FIG. 4, the EV sound effect generation system 100 includes the wireless sound generator module 112, the boost speaker 120, an external GPS antenna 124, and a wiring harness 128. The boost speaker 120 preferably is enclosed in a suitable housing for being mounted outside the vehicle 116 and protecting the speaker 120 from potential environmental damage. Further, the external GPS antenna 124 is configured to be installed onto a location of the vehicle 116 that is suitable for receiving “global positioning system” (GPS) data. In some embodiments, the external GPS antenna 124 is configured to be installed outside the vehicle 116, as shown in FIG. 1. The wireless sound generator module 112 is configured to determine the speed of the vehicle 116 by way of the external GPS antenna 124 and one or more internal accelerometers. An accurate measure of the speed of the vehicle 116 enables the wireless sound generator module 112 to simulate engine revving and transmission shifting, as described herein.

As will be appreciated, the wiring harness 128 is configured to electrically couple the EV sound effect generation system 100 with the vehicle 116. In the illustrated embodiment, the wiring harness 128 includes an antenna cable 132, power wires 136, and speaker wires 140. The antenna cable 132 is configured to couple the external GPS antenna 124 with the wireless sound generator module 112. The power wires 136 are configured to be connected to a source of DC electrical power source onboard the vehicle 116 such as by way of an electrical system comprising the vehicle 116. As such, the power wires 136 generally comprise a power wire 144 and a ground wire 148 for respectively connecting to a positive (+) terminal of the vehicle's battery and a negative (−) terminal of the battery. Further, the speaker wires 140 generally are configured for conducting electrical signals from the wireless sound generator module 112 to the boost speaker 120 comprising sound effects to be broadcast by the speaker 120.

As described herein, the wireless sound generator module 112 is configured to establish wireless communication with sound generator system 104 (see FIG. 1) by way of a mobile application 152 or an application server system 108 as shown in FIG. 1. In some embodiments, the sound generator system 104 comprises an interface 160 that provides access to a component systems package 164. A host site 168 provides a multiplicity of end-users 172 access to the application server system 108 by way of a communications network, such as the Internet. The end-users 172 may comprise vehicle drivers or vehicle servicing personnel, such as, by way of example, auto mechanics, technicians, vehicle owners, and the like, desiring to access and interact with sound effects to broadcast outside vehicles.

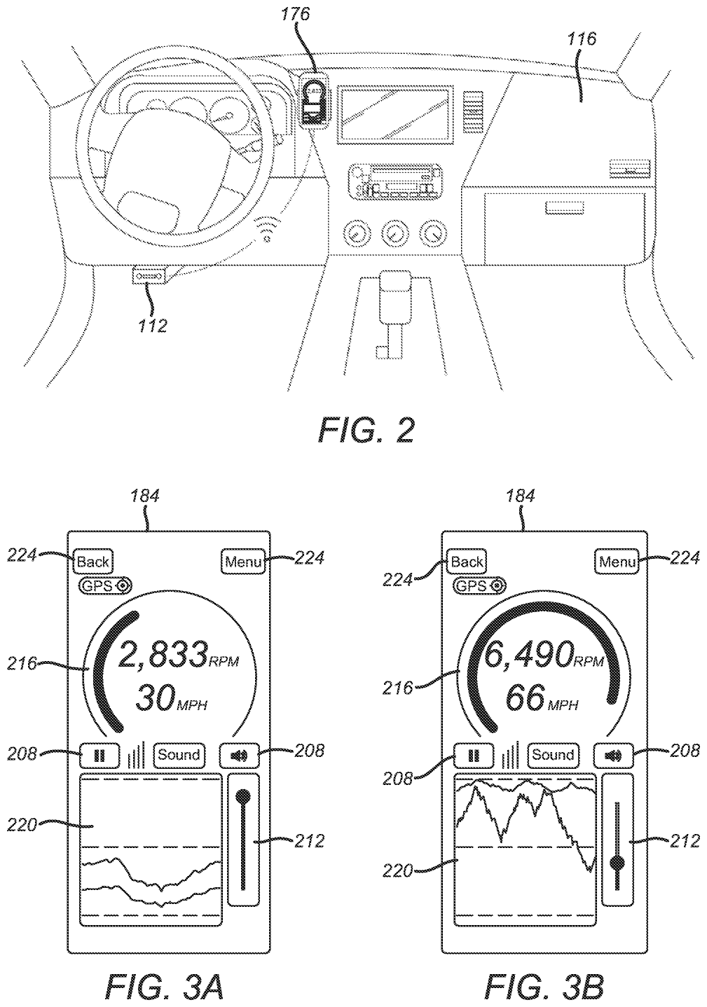

In some embodiments, the host site 168 comprises a web-based application whereby the end-users 172 interact with the component systems package 164. In some embodiments, the host site 168 may comprise a customized web-based mobile device application which enables service personnel and vehicle owners to directly interact with the component systems package 164. In some embodiments, the host site 168 and the sound generator system 104 may comprise a software application configured to operate on a mobile device and communicate with the wireless sound generator module 112 by way of a wireless connection. In such embodiments, the end-user 172 installs the wireless sound generator module 112 into the vehicle 116 and establishes a wireless connection between the wireless sound generator module 112 and a mobile device, such as a cellphone 176, as shown in FIG. 2. It is contemplated that the wireless connection between the sound generator module 112 and the cellphone 176 may comprise any wireless protocol suitable for transferring data, including any of Bluetooth, WiFi, NFC, and the like, without limitation.

It is contemplated that, in some embodiments, each of the end-users 172 may utilize applications stored on the memory of the application server system 108 to send demand signals, or “electronic orders,” to one or more of various content suppliers 180 so as to receive desired sound effects and other upgrades. The content suppliers 180 may comprise organizations, such as, by way of example, suppliers of sound effects files, firmware updates, application downloads, and the like. In some embodiments, the component systems package 164 is stored on the memory of the application server system 108, and the interface 160 is a software application which comprises a portion of the sound generator system 104, thereby providing access to the component systems package 164. In some embodiments, the component systems package 164 comprises functions that are performed by the wireless sound generator module 112 while the interface 160 is a software application that provides wireless access to settings that control the functions performed by the component systems package 164. In some embodiments, the component systems package 164 may be services operated by one or more third-party service providers. In such embodiments, the interface 160 may comprise a connection over the communications network, such as an Internet connection, whereby the application server system 108 may send requests to, and receive services from, the one or more third-party service providers.

As will be appreciated, the component systems package 164 generally comprises component systems whereby each end-user 172 may interact with sound effects provided by way of the wireless sound generator module 112. FIG. 3A illustrates an exemplary embodiment of a touch screen 184 that may be presented to the end-user 172, by way of the cellphone 176, whereby the component systems package 164 may be accessed. For example, the touch screen 184 may include various controls that enable the end-user 172 to select and operate sound effects by way of the component systems comprising the package 164. In the illustrated embodiment of FIG. 1, the component systems package 164 includes an engine rev system 188, a minimal operational voltage system 192, a wake-up system 196, a sound file header information read system 200, and a download system 204. In some embodiments, however, the component systems package 164 may comprise other systems in addition to the component systems illustrated in FIG. 1, without limitation and without deviating beyond the spirt and scope of the present disclosure. Each of the systems comprising the component systems package 164 is described below.

The engine rev system 188 generally is configured to enable a driver of the vehicle 116 to select and control sound effects to be broadcast outside the vehicle 116. For example, an exemplary embodiment of the engine rev system 188 that may be displayed to the end-user 172 by way of the cellphone 176 is shown in FIGS. 3A and 3B. As shown in FIG. 3A, the touch screen 184 includes buttons 208 that enable the driver to play a sound effect, pause the current sound effect, and select a difference sound effect to play. A volume slider 212 enables the driver to alter the volume of the sound emitted outside the vehicle 116. An upper portion of the touch screen 184 displays a simulated engine performance dial 216. The simulated engine performance dial 216 displays a current engine RPM and speed of the vehicle 116 that corresponds to the current sound effect being broadcast outside the vehicle 116. An output pane 220 displays a graph indicating previously simulated engine performance and vehicle speeds that has been displayed during the current driving session.

FIG. 3B illustrates an exemplary embodiment of the touch screen 184 during a relatively performance engine simulation. As will be appreciated, the simulated engine performance dial 216 shown in FIG. 3B displays an engine RMP and speed of the vehicle 116 that are much higher that the engine RMP and speed shown in FIG. 3A. Further, the output pane 220 shown in FIG. 3B indicates a relatively high-performance simulated engine output and vehicle 116 speed has occurred during the current driving session. Accordingly, the touch screen 184 shown in FIG. 3B indicates that the engine sound being broadcast outside the vehicle 116 corresponds to high performance engine revving and gear shifting. The touch screen 184 shown in FIG. 3A indicates that the engine sound being broadcast outside the vehicle 116 corresponds to lower engine speeds and relatively gentle gear shifting.

As shown in FIGS. 3A and 3B, the touch screen 184 includes one or more navigation buttons 224 that enable the driver to interact with the engine rev system 188. For example, in some embodiments, the driver may toggle between several different engine sounds. In some embodiments, the driver may broadcast a revving engine sound by touching an Engine Rev button (not shown). Further, the buttons 224 may enable the driver to initiate sound file downloads and firmware updates, as needed. Other functions of the navigation buttons 224 will be apparent to those skilled in the art without deviating beyond the spirit and scope of the present disclosure.

Turning, again, to FIG. 1, the minimum operational voltage system 192 is configured to detect an operational voltage available to the system 100 and ensure that the wireless sound generator module 112 does not fully function when the operational voltage drops below a minimal value. In some embodiments, the minimal operational voltage system 192 comprises a portion of the wireless sound generator module 192. In such embodiments, the minimum operational voltage system 192 remains functional and detects available voltage values in absence of the cellphone 176. In some embodiments, the minimum operational voltage system 192 is configured to put the wireless sound generator module 112 into a sleep mode when the available voltage drops to a minimal value, such as when the vehicle 116 is turned off.

The wake-up system 196 is configured to wake the wireless sound generator module 112 from a low-current, sleep mode so that it can function normally. For example, when the vehicle 116 is turned on, the wake-up system 196 detects that the vehicle 116 is operating and wakes the wireless sound generator module 112 from the sleep mode. The wireless sound generator module 112 may then broadcast a selected engine sound. In some embodiments, the wake-up system 196 comprises a portion of the wireless sound generator module 112 and thus is operable in absence of the cellphone 176 shown in FIG. 2. In some embodiments, however, the wake-up system 196 comprises an external, remote-mount module configured to wake up the wireless sound generator module 112 in absence of the cellphone 176.

The sound file header information read system 200 is configured to read information included in the header portion of sound files so as to improve sound quality and make sound effects more realistic. For example, sound file header information may include information pertaining to any one or more of maximum engine RPM, minimum engine RPM, shift points, shift delays, maximum volume, treble adjustments, bass adjustments, and the like, without limitation. In some embodiments, the sound file header information read system 200 may be configured to read sound file header information and then automatically trim treble and bass of sound effects in response to particular combinations of boost speakers 120, speaker enclosures, and sound files, without limitation.

The download system 204 is configured to enable the end-user 172 to obtain new sound files and firmware updates quickly and easily, as needed. In some embodiments, when the end-user 172 selects a sound file to download, the download system 204 directs the cellphone 176 to a website related to one of the content suppliers 180 whereby the end-user 172 may obtain new sound files and/or firmware updates. For example, when the end-user 172 selects a desired sound effect file, the download system 204 redirects the cellphone 176 to the website of the content supplier 144 that sells or otherwise offers the desired sound effect file for download. As will be appreciated, once the cellphone 176 is redirected to the website, the end-user 172 may obtain the sound effect file, as desired.

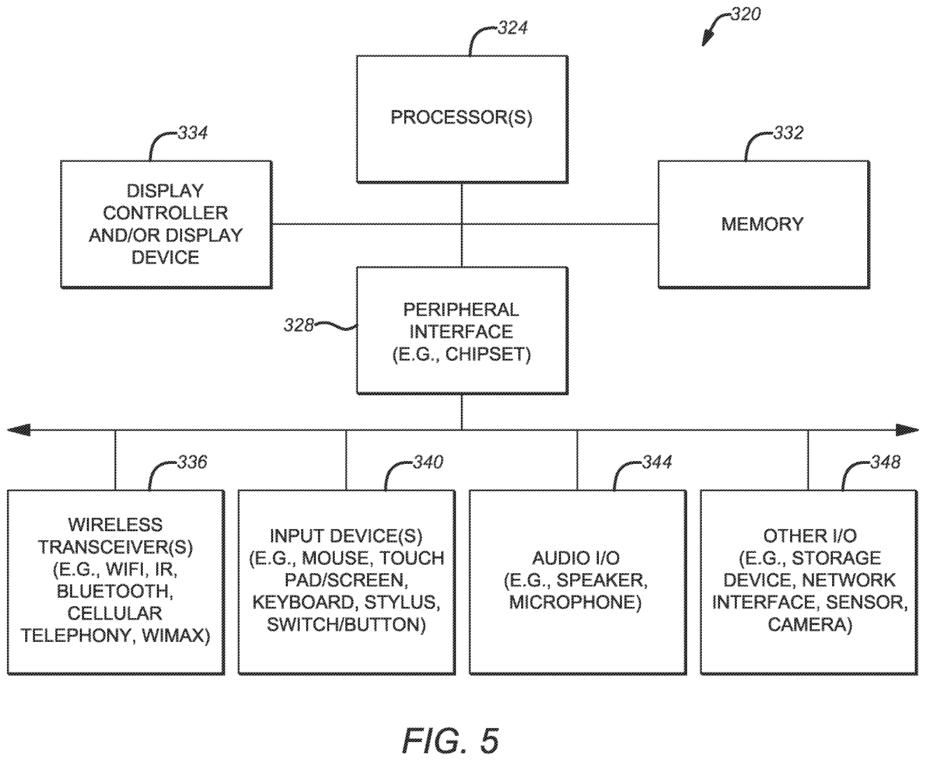

FIG. 5 is a block diagram illustrating an exemplary data processing system 320 that may be used in conjunction with the EV sound effect generation system 100 to perform any of the processes or methods described herein. System 320 may represent a desktop, a tablet, a server, a mobile phone, a personal digital assistant (PDA), a personal communicator, a network router or hub, a wireless access point (AP) or repeater, a set-top box, or a combination thereof.

In an embodiment, illustrated in FIG. 5, system 320 includes a processor 324 and a peripheral interface 328, also referred to herein as a chipset, to couple various components to the processor 324, including a memory 332 and devices 336-348 via a bus or an interconnect. Processor 324 may represent a single processor or multiple processors with a single processor core or multiple processor cores included therein. Processor 324 may represent one or more general-purpose processors such as a microprocessor, a central processing unit (CPU), or the like. More particularly, processor 324 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 324 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 324 is configured to execute instructions for performing the operations and steps discussed herein.

Peripheral interface 328 may include a memory control hub (MCH) and an input output control hub (ICH). Peripheral interface 328 may include a memory controller (not shown) that communicates with a memory 332. The peripheral interface 328 may also include a graphics interface that communicates with graphics subsystem 334, which may include a display controller and/or a display device. The peripheral interface 328 may communicate with the graphics device 334 by way of an accelerated graphics port (AGP), a peripheral component interconnect (PCI) express bus, or any other type of interconnects.

An MCH is sometimes referred to as a Northbridge, and an ICH is sometimes referred to as a Southbridge. As used herein, the terms MCH, ICH, Northbridge and Southbridge are intended to be interpreted broadly to cover various chips that perform functions including passing interrupt signals toward a processor. In some embodiments, the MCH may be integrated with the processor 324. In such a configuration, the peripheral interface 328 operates as an interface chip performing some functions of the MCH and ICH. Furthermore, a graphics accelerator may be integrated within the MCH or the processor 324.

Memory 332 may include one or more volatile storage (or memory) devices, such as random access memory (RAM), dynamic RAM (DRAM), synchronous DRAM (SDRAM), static RAM (SRAM), or other types of storage devices. Memory 332 may store information including sequences of instructions that are executed by the processor 324, or any other device. For example, executable code and/or data of a variety of operating systems, device drivers, firmware (e.g., input output basic system or BIOS), and/or applications can be loaded in memory 332 and executed by the processor 324. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 328 may provide an interface to IO devices, such as the devices 336-348, including wireless transceiver(s) 336, input device(s) 340, audio IO device(s) 344, and other IO devices 348. Wireless transceiver 336 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 340 may include a mouse, a touch pad, a touch sensitive screen (which may be integrated with display device 334), a pointer device such as a stylus, and/or a keyboard (e.g., physical keyboard or a virtual keyboard displayed as part of a touch sensitive screen). For example, the input device 340 may include a touch screen controller coupled with a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 344 may include a speaker and/or a microphone to facilitate voice-enabled functions, such as voice recognition, voice replication, digital recording, and/or telephony functions. Other optional devices 348 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 348 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 5 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with embodiments of the invention disclosed hereinabove.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g., circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

While the EV sound effect generation system and methods have been described in terms of particular variations and illustrative figures, those of ordinary skill in the art will recognize that the EV sound effect generation system is not limited to the variations or figures described. In addition, where methods and steps described above indicate certain events occurring in certain order, those of ordinary skill in the art will recognize that the ordering of certain steps may be modified and that such modifications are in accordance with the variations of the EV sound effect generation system. Additionally, certain of the steps may be performed concurrently in a parallel process, when possible, as well as performed sequentially as described above. To the extent there are variations of the EV sound effect generation system, which are within the spirit of the disclosure or equivalent to the EV sound effect generation system found in the claims, it is the intent that this patent will cover those variations as well. Therefore, the present disclosure is to be understood as not limited by the specific embodiments described herein, but only by scope of the appended claims.

What is claimed is:

1. A sound effect generation system for broadcasting an engine sound outside a vehicle, comprising:
a wireless sound generator module for simulating the engine sound;
a boost speaker for broadcasting the engine sound outside the vehicle; and
an external GPS antenna for measuring a speed of the vehicle.

2. The sound effect generation system of claim 1, further comprising a sound generator system stored on a memory of a mobile device that comprises at least one processor and has connectivity to the wireless sound generator module.

3. The sound effect generation system of claim 2, wherein the sound generator system comprises a software application configured to operate on the mobile device and communicate with the wireless sound generator module by way of the wireless connection.

4. The sound effect generation system of claim 1, wherein the wireless sound generator module is configured to simulate the engine sound when the vehicle is operating.

5. The sound effect generation system of claim 1, wherein the engine sound is configured to resemble an idling internal combustion engine when the vehicle is turned on and remains stationary.

6. The sound effect generation system of claim 1, wherein the engine sound simulates revving of the internal combustion engine and shifting of a transmission when the speed of the vehicle increases.

7. The sound effect generation system of claim 1, wherein the engine sound simulates a decelerating internal combustion engine sound when the speed of the vehicle decreases.

8. The sound effect generation system of claim 1, wherein the wireless sound generator module is configured to simulate engine revving and transmission shifting based on GPS data and one or more internal accelerometers.

9. A wireless sound generator module for simulating an engine sound, comprising:
an engine rev system;
a minimum operational voltage system;
a wake-up system;
a sound file header information read system; and
a download system.

10. The wireless sound generator module of claim 9, wherein the wireless sound generator module is configured to wirelessly communicate with a sound generator system comprising a software application operating on a mobile device whereby an end-user may select and control the engine sound to be simulated during operation of a vehicle.

11. The wireless sound generator module of claim 9, wherein the engine rev system is configured to simulate the engine sound during operation of a vehicle.

12. The wireless sound generator module of claim 9, wherein the minimum operational voltage system is configured to detect an available operational voltage and ensure that the wireless sound generator module does not fully function when the operational voltage drops below a minimal value.

13. The wireless sound generator module of claim 9, wherein the wake-up system is configured to wake the wireless sound generator module from a low-current, sleep mode so that it can function normally.

14. The wireless sound generator module of claim 9, wherein the sound file header information read system is configured to read information included in the header portion of sound files so as to improve sound quality and make sound effects more realistic.

15. The wireless sound generator module of claim 9, wherein the download system is configured to enable end-users to obtain new sound files and firmware updates.

16. A method for broadcasting an engine sound outside an operating vehicle, comprising:
providing a sound of an operating internal combustion engine;
receiving sound-settings from an end-user;
determining a speed of the operating vehicle;
altering the sound according to the speed and the sound-settings; and
broadcasting the sound outside the vehicle by way of a boost speaker.

17. The method of claim 16, wherein determining the speed includes utilizing GPS data and one or more accelerometers comprising a wireless sound generator module.

18. The method of claim 16, wherein altering includes causing the sound to resemble an idling internal combustion engine when the vehicle is turned on and remains stationary.

19. The method of claim 16, wherein altering includes simulating revving of the internal combustion engine and shifting of a transmission when the speed of the vehicle increases.

20. The method of claim 16, wherein altering includes simulating a decelerating internal combustion engine sound when the speed of the vehicle decreases.
